(19) United States
(12) Patent Application Publication
(10) Pub. No.: US 2019/0030991 A1
(43) Pub. Date: Jan. 31, 2019

(54) THERMAL MANAGEMENT DEVICE FOR VEHICLE

(71) Applicant: DENSO CORPORATION, Kariya-city, Aichi-pref. (JP)

(72) Inventors: Norihiko ENOMOTO, Kariya-city (JP); Yoshiki KATO, Kariya-city (JP); Kengo SUGIMURA, Kariya-city (JP); Nobuyuki HASHIMURA, Kariya-city (JP); Koji MIURA, Kariya-city (JP); Keigo SATO, Kariya-city (JP); Ariel MARASIGAN, Kariya-city (JP)

(21) Appl. No.: 16/073,357

(22) PCT Filed: Jan. 20, 2017
(86) PCT No.: PCT/JP2017/001837

§ 371 Date: Jul. 27, 2018

(30) Foreign Application Priority Data
Jan. 29, 2016 (JP) 2016-015614
Dec. 5, 2016 (JP) 2016-236055

(51) Int. Cl. B60H 1/08; B60H 1/22; B60H 1/00; B60H 1/03

(52) U.S. Cl. CPC B60H 1/08; B60H 1/22; B60L 2240/36; B60H 1/03; B60H 2001/00307; B60H 1/00885

(57) ABSTRACT

A thermal management device includes a waste-heat supply device that supplies waste heat to a heat medium flowing through a second heat medium path portion, a heater core that exchanges heat between air and the heat medium, a switching valve that switches between a state in which the heat medium circulates between the heater core and a first heat medium path portion and a state in which the heat medium circulates between the heater core and the second heat medium path portion, an adjustment portion that adjusts a temperature of the heat medium in the first heat medium path portion, and a controller. The controller controls the adjustment portion such that the temperature of the heat medium in the first heat medium path portion is equal to or higher than a predetermined temperature when the switching valve circulates the heat medium between the heater core and the second heat medium path portion.

### CROSS REFERENCE TO RELATED APPLICATION

This application is based on Japanese Patent Applications No. 2016-015614 filed on Jan. 29, 2016 and No. 2016-236055 filed on Dec. 5, 2016, the contents of which are incorporated herein by reference in its entirety.

### FIELD OF THE INVENTION

The present disclosure relates to a thermal management device for use in a vehicle.

### BACKGROUND ART

Conventionally, for example, Patent Document 1 describes a thermal management device for a vehicle that is capable of performing air-heating of a vehicle interior using waste heat from an engine and waste heat from an electric device. In the related art, such a vehicle thermal management device can selectively switch the passage of a coolant to the engine, the electric device, or an air-conditioning heat exchanger by using a valve unit.

The vehicle interior can be heated using waste heat from the engine by passing the coolant through the engine and the air-conditioning heat exchanger. On the other hand, the vehicle interior can also be heated using waste heat from the electric device by passing the coolant through the electric device and the air-conditioning heat exchanger.

### RELATED ART DOCUMENT

### Patent Document

[Patent Document 1] WO 2011/015426

### SUMMARY OF INVENTION

The upper limit of the coolant flowing through the electric device is generally set at approximately 70° C. in consideration of heat resistance of electronic components. Meanwhile, the coolant temperature that has been used to cool the engine generally reaches 90° C. or higher. Thus, the coolant used to cool the engine is not allowed to pass through the electric device.

According to the studies conducted by the inventors of the present application, in the above-mentioned related art, either the waste heat from the engine or the waste heat from the electric device needs to be selectively switched and utilized as an air-heating heat source. As a result, in the above-mentioned related art, the temperature of the coolant flowing into the air-conditioning heat exchanger varies when switching the air-heating heat source, and thereby the temperature of air blown into the vehicle interior also varies, thus easily making an occupant feel uncomfortable.

Both the waste heat from the engine and the waste heat from the electric device cannot be utilized as the air-heating heat source at the same time. Consequently, the waste heat can be difficult to use effectively.

In view of the foregoing matter, it is an object of the present disclosure to suppress variations in the temperature of air to be blown into the vehicle interior in a thermal management device for a vehicle that includes a heating heat exchanger to heat the air to be blown into the vehicle interior when switching a heat medium flowing into the heating heat exchanger.

Furthermore, in view of the foregoing matter, it is another object of the present disclosure to effectively use waste heat from a plurality of heat sources.

A thermal management device for a vehicle according to an aspect of the present disclosure includes: a first heat medium path portion and a second heat medium path portion, through which a heat medium flows; a waste-heat supply device configured to supply waste heat to the heat medium flowing through the second heat medium path portion; a heating heat exchanger that exchanges heat between air to be blown into a vehicle interior and the heat medium to heat the air; a switching portion that switches between a state in which the heat medium circulates between the heating heat exchanger and the first heat medium path portion, and a state in which the heat medium circulates between the heating heat exchanger and the second heat medium path portion; an adjustment portion configured to adjust a temperature of the heat medium in the first heat medium path portion; and a controller configured to control an operation of the adjustment portion such that the temperature of the heat medium in the first heat medium path portion is equal to or higher than a predetermined temperature when the switching portion is set to circulate the heat medium between the heating heat exchanger and the second heat medium path portion.

With this configuration, the heat medium having its temperature adjusted by the adjustment portion flows into the heating heat exchanger, when the state in which the heat medium circulates between the heating heat exchanger and the second heat medium path portion is switched to the state in which the heat medium circulates between the heating heat exchanger and the first heat medium path portion. Thus, variations in the temperature of the heat medium flowing into the heating heat exchanger can be suppressed, and thereby variations in the temperature of the air to be blown into the vehicle interior can also be suppressed.

A thermal management device for a vehicle according to another aspect of the present disclosure includes: a first waste-heat supply device configured to supply waste heat to a heat medium; a second waste-heat supply device configured to supply waste heat to the heat medium, the second waste-heat supply device having a high allowable temperature, compared to the first waste-heat supply device; a heating heat exchanger that exchanges heat between air to be blown into a vehicle interior and the heat medium to heat the air; a first heat medium path portion through which the heat medium flows, and in which the first waste-heat supply device is disposed; a second heat medium path portion through which the heat medium flows, and in which the second waste-heat supply device is disposed; an outside-air heat radiator that dissipates heat of the heat medium in the first heat medium path portion into outside air by exchanging heat between the heat medium in the first heat medium path portion and the outside air; a switching portion configured to switch between a state in which the heat medium in the first heat medium path portion flows to the outside-air heat radiator and a state in which a flow of the heat medium in the first heat medium path portion to the outside-air heat radiator is blocked, while switching between a state in which the heat medium circulates between the heating heat exchanger and the first heat medium path portion and a state in which the heat medium circulates between the heating heat exchanger and the second heat medium path portion; and a controller configured to control an operation of the switching portion such that the flow of the heat medium in the first heat medium path portion to the outside-air heat radiator is blocked when the heat medium circulates between the heating heat exchanger and the second heat medium path portion.

With this configuration, when the waste heat from the second waste-heat supply device is used to perform air-heating, the waste heat from the first waste-heat supply device can be suppressed from being dissipated into the outside air in the outside-air heat radiator, so that the waste heat from the first waste-heat supply device can be stored in the heat medium of the first heat medium path portion.

Thus, when the heat medium circulates between the heating heat exchanger and the first heat medium path portion, the air-heating can be performed by using waste heat from the first waste-heat supply device, stored in the heat medium in the first heat medium path portion. Consequently, both waste heat from the first waste-heat supply device and waste heat from the second waste-heat supply device can be effectively used for the air-heating.

### BRIEF DESCRIPTION OF THE DRAWINGS

FIG. 1 is an entire configuration diagram of a vehicle thermal management device in an embodiment;

FIG. 2 is an entire configuration diagram showing a first operating mode of the vehicle thermal management device in the embodiment;

FIG. 3 is an entire configuration diagram showing a second operating mode of the vehicle thermal management device in the embodiment;

FIG. 4 is an entire configuration diagram showing a third operating mode of the vehicle thermal management device in the embodiment; and

FIG. 5 is a block diagram showing an electric controller of the vehicle thermal management device in the embodiment.

### DESCRIPTION OF EMBODIMENTS

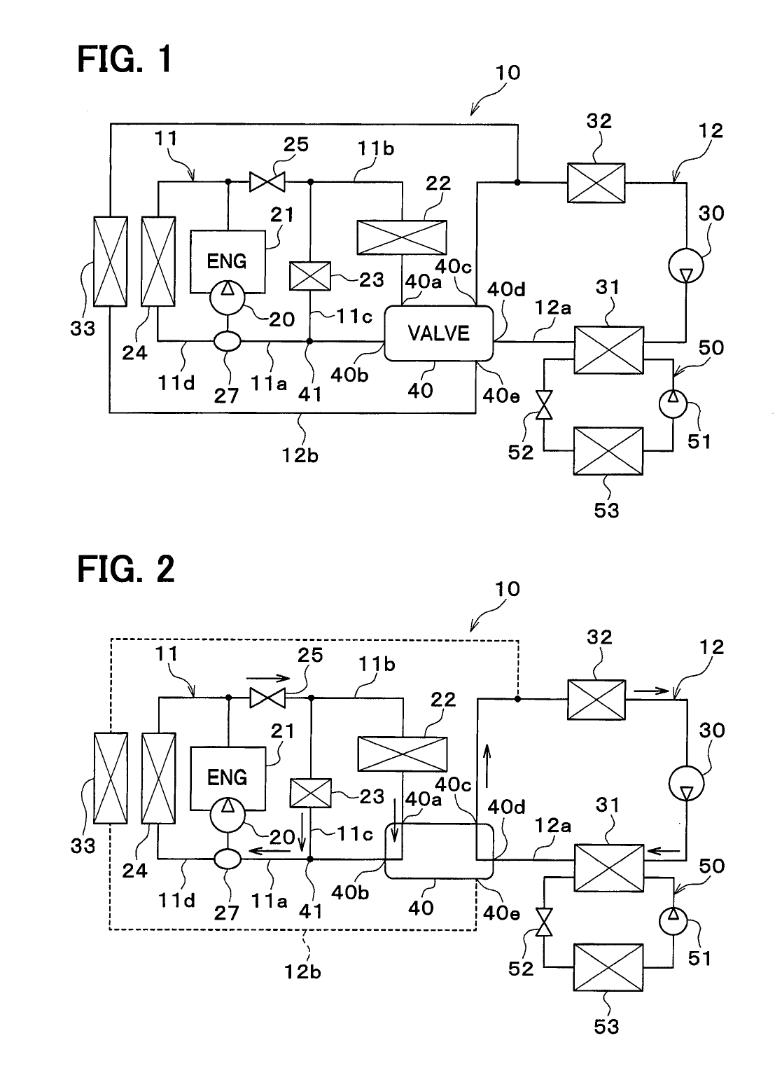

Hereinafter, embodiments will be described with reference to the accompanying drawings. A vehicle thermal management device 10 shown in FIG. 1 is used to adjust various devices mounted on a vehicle or the vehicle interior to an appropriate temperature.

In the present embodiment, the vehicle thermal management device 10 is applied to a hybrid vehicle that can obtain a driving force for traveling from both an engine and a traveling electric motor.

The hybrid vehicle of the present embodiment is configured as a plug-in hybrid vehicle that can charge a battery mounted on the vehicle, with power supplied from an external power source during stopping of the vehicle. For example, a lithium ion battery can be used as the battery.

The driving force output from the engine is used not only to cause the vehicle to travel, but also to operate a generator. Power generated by the generator and power supplied from the external power source can be stored in the battery. Power stored in the battery is supplied not only to the traveling electric motor, but also to various vehicle-mounted devices, such as electric components included in the vehicle thermal management device 10.

The vehicle thermal management device 10 includes an engine cooling circuit 11 and a condenser circuit 12. Each of the engine cooling circuit 11 and the condenser circuit 12 is a coolant circuit through which a coolant circulates.

The coolant is a fluid as the heat medium. For example, the coolant is a liquid containing at least ethylene glycol, dimethylpolysiloxane or a nanofluid, or an antifreezing solution.

The engine cooling circuit 11 is a coolant circuit for cooling the engine 21 with the coolant. An engine pump 20, an engine 21, a heater core 22, a coolant circulation device 23, and a first radiator 24 are disposed in the engine cooling circuit 11.

The engine 21 serves as a waste heat supply device that supplies waste heat generated along with the operation of the vehicle, to the coolant in the engine cooling circuit 11. The allowable temperature for the engine 21 is approximately 90° C. The engine pump 20 is a pump that draws and discharges the coolant. The engine pump 20 is an electric pump.

The engine pump 20 may be a belt-driven pump. The belt-driven pump is a pump that is driven by a driving force of the engine 21 transmitted thereto via the belt.

The heater core 22 is a heating heat exchanger that heats air to be blown into the vehicle interior by exchanging heat between the coolant and the air, which is to be blown into the vehicle interior. The heater core 22 is a heat exchanger used to perform air-heating of the vehicle interior. The air is blown into the vehicle interior by an indoor blower (not shown).

The engine pump 20, the engine 21, and the heater core 22 are arranged in series with one another in the engine cooling circuit 11 such that the coolant circulates therethrough in this order.

The coolant circulation device 23 is a device through which the coolant circulates. The coolant circulation device 23 is disposed in parallel with the heater core 22 in the coolant flow.

The coolant circulation device 23 is, for example, an exhaust gas recirculation (EGR) cooler or an exhaust heat recovery device. The EGR cooler is a heat exchanger that cools the exhaust gas by exchanging heat between the coolant and the exhaust gas to be returned to the intake side of the engine 21. The exhaust heat recovery unit 24 is a heat exchanger that recovers the heat of the exhaust gas by exchanging heat between the exhaust gas from the engine 21 and the coolant. The coolant circulation device 23 is a heat generating device that generates heat during operation.

The first radiator 24 is a coolant outside-air heat exchanger that exchanges heat between the coolant and the air outside a vehicle cabin (hereinafter referred to as the outside air) to dissipate heat of the coolant into the outside air. The first radiator 24 is arranged in parallel with the heater core 22 and the coolant circulation device 23 in the flow of the coolant.

The engine cooling circuit 11 includes an engine path portion 11a, a heater core path portion 11b, a device path portion 11c, and a first radiator path portion 11d. Each of the engine path portion 11a, the heater core path portion 11b, the device path portion 11c, and the first radiator path portion 11d forms a coolant flow passage through which the coolant flows.

The engine pump 20, the engine 21, and a shut-off valve 25 are arranged in series with one another in the engine path portion 11a. The engine path portion 11a is a heat-medium path portion through which the heat medium flows.

The shut-off valve 25 is a solenoid valve that opens and closes the coolant flow passage in the engine path portion 11a. The shut-off valve 25 is disposed on the downstream side of the coolant flow with respect to the engine pump 20 and the engine 21 in the engine path portion 11a.

The heater core 22 is disposed in the heater core path portion 11b. The coolant circulation device 23 is disposed in the device path portion 11c. The heater core path portion 11b and the device path portion 11c are connected in parallel with each other with respect to the engine path portion 11a.

The first radiator 24 is disposed in the first radiator path portion 11d. One end of the first radiator path portion 11d is connected to a part of the engine path portion 11a on the upstream side of the coolant flow with respect to the engine pump 20 and the engine 21. The other end of the first radiator path portion 11d is connected to a part of the engine path portion 11a on the downstream side of the coolant flow with respect to the engine pump 20 and the engine 21 and on the upstream side of the coolant flow with respect to the shut-off valve 25.

A thermostat 27 is disposed in a connection portion between the first radiator path portion 11d and the engine path portion 11a. The thermostat 27 is a coolant thermo-sensitive valve. The coolant thermo-sensitive valve is a valve including a mechanical system that opens and closes a coolant flow passage by displacing a valve body using thermowax, which has its volume changeable depending on the coolant temperature.

A condenser pump 30 and a condenser 31 are disposed in the condenser circuit 12. The condenser pump 30 is a pump that draws and discharges the coolant. The condenser pump 30 is an electric pump. The condenser pump 30 may be a belt-driven pump.

The condenser 31 is an adjusting portion that adjusts the coolant temperature by heating the coolant. The condenser 31 is a high-pressure side heat exchanger that heats the coolant by exchanging heat between the coolant and a high-pressure side refrigerant in a refrigeration cycle 50.

The condenser circuit 12 has a condenser path portion 12a. The condenser path portion 12a forms a coolant circulation flow passage through which the coolant circulates. The condenser path portion 12a is a heat medium path portion through which a heat medium flows. The condenser path portion 12a is a first heat medium path portion, and the engine path portion 11a of the engine cooling circuit 11 is a second heat medium path portion.

The condenser pump 30, the condenser 31, and an electric device 32 are arranged in series with one another in the condenser path portion 12a. The electric device 32 is a heat generator that generates heat during operation to discharge exhaust heat therefrom. The electric device 32 is a waste-heat supply device that supplies waste heat to the coolant flowing through the condenser circuit 12. The allowable temperature for the electric device 32 is approximately 70° C.

The electric device 32 is a first waste-heat supply device, whereas the engine 21 is a second waste-heat supply device. The engine 21 has the high allowable temperature, compared with the electric device 32.

The refrigeration cycle 50 is a vapor-compression refrigerator that includes a compressor 51, the condenser 31, an expansion valve 52, and an evaporator 53. The refrigerant of the refrigeration cycle 50 is a fluorocarbon refrigerant. The refrigeration cycle 50 is a subcritical refrigeration cycle in which a high-pressure side refrigerant pressure does not exceed the critical pressure of the refrigerant.

The compressor 51 is an electric compressor driven by power supplied from the battery. The compressor 51 draws and compresses the refrigerant in the refrigeration cycle 50 to discharge the compressed refrigerant therefrom. The compressor 51 may be a variable displacement compressor that is driven by the driving force of the engine 21 via an engine belt.

The condenser 31 is a condensing device that condenses a high-pressure refrigerant by exchanging heat between the high-pressure refrigerant discharged from the compressor 51 and the coolant.

The expansion valve 52 is a decompression portion that decompresses and expands a liquid-phase refrigerant flowing out of the condenser 31. The expansion valve 52 has a thermo-sensitive portion. The thermo-sensitive portion detects a superheat degree of the refrigerant on the outlet side of the evaporator 53 based on the temperature and pressure of the refrigerant on the outlet side of the evaporator 53. The expansion valve 52 is a thermal expansion valve that adjusts the throttle passage area by a mechanical system such that the superheat degree of the refrigerant on the outlet side of the evaporator 53 is within a predetermined range. The expansion valve 52 may be an electric expansion valve that adjusts the throttle passage area by an electric mechanism.

The evaporator 53 is a low-pressure side heat exchanger that evaporates a low-pressure refrigerant by exchanging heat between the low-pressure refrigerant decompressed and expanded by the expansion valve 52 and the air to be blown into the vehicle interior. The gas-phase refrigerant evaporated at the evaporator 53 is drawn into and compressed by the compressor 51.

The evaporator 53 may be a heat medium cooler that cools the coolant by exchanging heat between the refrigerant and the coolant. In this case, a heat-medium air heat exchanger is separately provided to exchange heat between the air and the coolant cooled by the heat medium cooler, thereby making it possible to cool the air to be blown into the vehicle interior.

The engine cooling circuit 11 and the condenser circuit 12 are connected to a switching valve 40. The switching valve 40 switches the flow of the coolant between the engine cooling circuit 11 and the condenser circuit 12.

That is, the switching valve 40 switches between a state in which the coolant circulates between the engine cooling circuit 11 and the condenser circuit 12 and a state in which the coolant does not circulate between the engine cooling circuit 11 and the condenser circuit 12. In other words, the switching valve 40 switches between a state in which the engine cooling circuit 11 and the condenser circuit 12 communicate with each other and a state in which the engine cooling circuit 11 and the condenser circuit 12 do not communicate with each other.

A second radiator path 12b is connected to the switching valve 40. A second radiator 33 is disposed in the second radiator path 12b. The second radiator 33 is an outside-air heat radiator that dissipates heat from the coolant into the outside air by exchanging heat between the coolant and the outside air. The second radiator 33 is an adjusting portion that adjusts the coolant temperature by dissipating heat from the coolant.

The switching valve 40 is a five-way valve having five ports. A first port 40a of the switching valve 40 is connected to a part of the heater core path portion 11b on the coolant outlet side of the heater core 22. A second port 40b of the switching valve 40 is connected to a junction 41 between an end on the coolant suction side of the engine pump 20 and the device path portion 11c in the engine path portion 11a.

A third port 40c of the switching valve 40 is connected to a part on the coolant inlet side of the electric device 32 in the condenser path portion 12a. A fourth port 40d of the switching valve 40 is connected to a part on the coolant outlet side of the condenser 31 in the condenser path portion 12a.

A fifth port 40e of the switching valve 40 is connected to one end of the second radiator path 12b. The other end of the second radiator path 12b is connected to a part between the third port 40c of the switching valve 40 and the electric device 32 in the condenser path portion 12a.

The shut-off valve 25 and the switching valve 40 are switching portions that switch between a state in which the coolant circulates between the heater core 22 and the condenser path portion 12a and a state in which the coolant circulates between the heater core 22 and the engine path portion 11a.

In other words, the shut-off valve 25 and the switching valve 40 switch between a state in which the heater core 22 communicates with the condenser path portion 12a and a state in which the heater core 22 communicates with the engine path portion 11a.

The switching valve 40 switches between a state in which the coolant in the condenser circuit 12 flows to the second radiator 33 and a state in which the flow of the coolant in the condenser circuit 12 to the second radiator 33 is blocked. In other words, the switching valve 40 switches between a state in which the second radiator 33 communicates with the condenser circuit 12 and a state in which the second radiator 33 does not communicates with the condenser circuit 12.

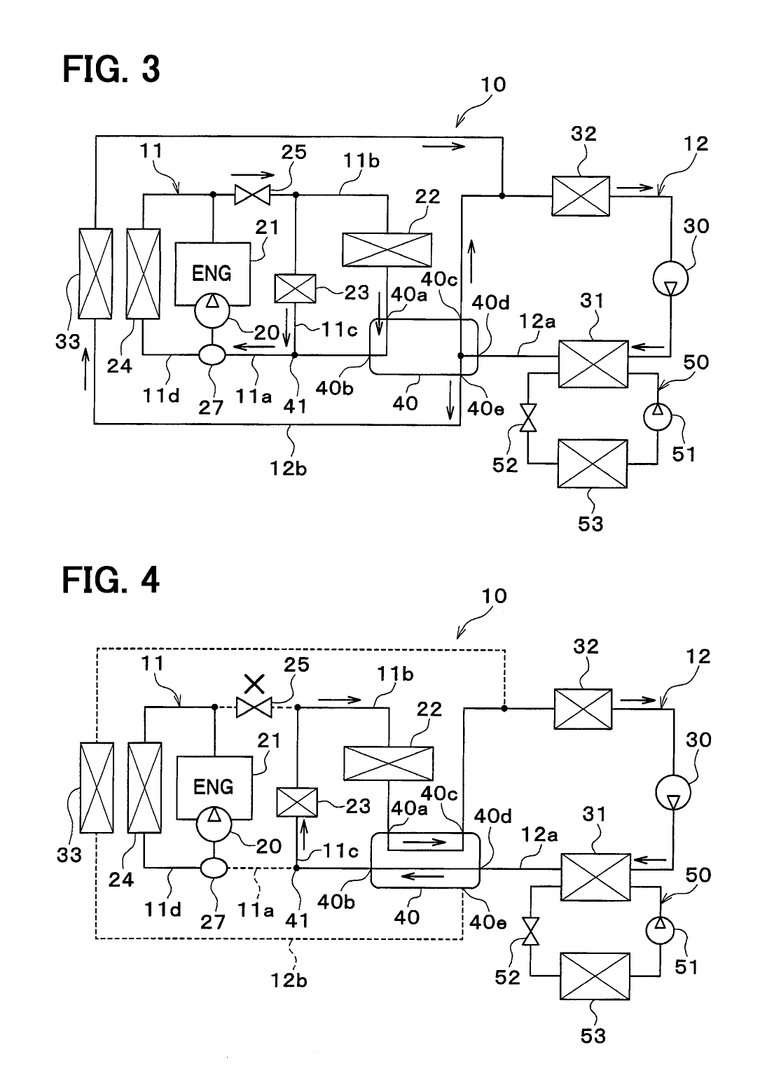

The shut-off valve 25 and the switching valve 40 switch the operating mode of the vehicle thermal management device 10 among a first operating mode shown in FIG. 2, a second operating mode shown in FIG. 3, and a third operating mode shown in FIG. 4.

In the first operating mode shown in FIG. 2, the switching valve 40 blocks the circulation of the coolant between the engine cooling circuit 11 and the condenser circuit 12, and also blocks the circulation of the coolant between the second radiator 33 and the condenser circuit 12.

Specifically, the switching valve 40 connects the first port 40a and the second port 40b, connects the third port 40c and the fourth port 40d, and closes the fifth port 40e. In the first operating mode, the shut-off valve 25 opens a coolant flow passage in the engine path portion 11a.

Thus, in the engine cooling circuit 11, the coolant flowing out of the engine 21 flows through the heater core 22 and the coolant circulation device 23 in parallel to enter the engine 21. In other words, the coolant flowing out of the engine path portion 11a flows through the heater core path portion 11b and the device path portion 11c in parallel to enter the engine path portion 11a. In the condenser circuit 12, the coolant does not circulate through the second radiator 33.

In the second operating mode shown in FIG. 3, the switching valve 40 blocks the circulation of the coolant between the engine cooling circuit 11 and the condenser circuit 12, and circulates the coolant between the second radiator 33 and the condenser circuit 12.

Specifically, the switching valve 40 connects the first port 40a and the second port 40b and also connects the third port 40c, the fourth port 40d, and the fifth port 40e. In the second operating mode, the shut-off valve 25 opens a coolant flow passage in the engine path portion 11a.

Thus, in the engine cooling circuit 11, like the first operating mode, the coolant flowing out of the engine 21 flows through the heater core 22 and the coolant circulation device 23 in parallel to enter the engine 21. In other words, the coolant flowing out of the engine path portion 11a flows through the heater core path portion 11b and the device path portion 11c in parallel to enter the engine path portion 11a. In the condenser circuit 12, the coolant circulates through the second radiator 33.

In the third operating mode shown in FIG. 4, the switching valve 40 circulates the coolant between the engine cooling circuit 11 and the condenser circuit 12 and blocks the circulation of the coolant between the second radiator 33 and the condenser circuit 12.

Specifically, the switching valve 40 connects the first port 40a and the third port 40c, connects the second port 40b and the fourth port 40d, and closes the fifth port 40e. In the third operating mode, the shut-off valve 25 closes a coolant flow passage in the engine path portion 11a.

Thus, in the condenser circuit 12, the coolant flowing out of the condenser 31 flows through the coolant circulation device 23, the heater core 22, and the electric device 32 in series in this order to enter the condenser 31. In other words, the coolant in the condenser path portion 12a flows through the device path portion 11c and the heater core path portion 11b in series in this order to enter the condenser path portion 12a. In the engine cooling circuit 11, the coolant circulates through the engine 21 and the first radiator 24.

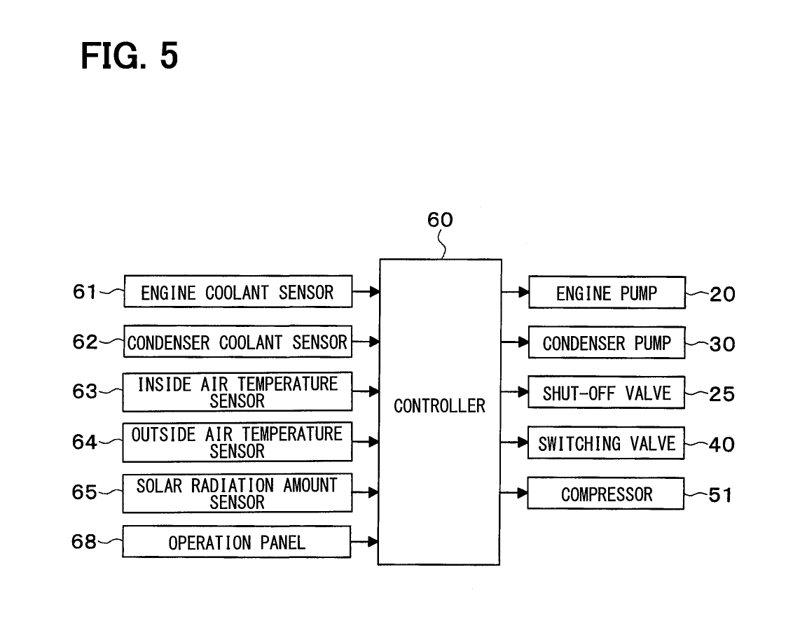

Next, the electric controller of the vehicle thermal management device 10 will be described with reference to FIG. 5. A controller 60 is configured of a known microcomputer, including a CPU, a ROM, and a RAM, and a peripheral circuit thereof. The controller 60 performs various calculations and processing based on a control program stored in the ROM. Various control target devices are connected to the output side of the controller 60. The controller 60 is a control unit that controls the operations of various control target devices.

The control target devices controlled by the controller 60 include the engine pump 20, the condenser pump 30, the shut-off valve 25, the switching valve 40, the compressor 51, and the like.

Detection signals from a group of sensors are input to the input side of the controller 60. The sensor group includes an engine coolant temperature sensor 61, a condenser coolant temperature sensor 62, an inside air temperature sensor 63, an outside air temperature sensor 64, and a solar radiation amount sensor 65.

The engine coolant temperature sensor 61 is a heat-medium temperature detector that detects the coolant temperature in the engine cooling circuit 11. Specifically, the engine coolant temperature sensor 61 detects the coolant temperature in the engine path portion 11a.

The condenser coolant temperature sensor 62 is a heat-medium temperature detector that detects the coolant temperature in the condenser circuit 12. Specifically, the condenser coolant temperature sensor 62 detects the coolant temperature in the condenser path portion 12a.

The inside air temperature sensor 63 is an inside air temperature detector that detects the temperature of the inside air. The outside air temperature sensor 64 is an outside air temperature detector that detects the temperature of the outside air. The solar radiation amount sensor 65 is a solar radiation amount detector that detects the amount of solar radiation in the vehicle interior.

An operation panel 68 is disposed near an instrument board at the front of the vehicle cabin. Operation signals from various air-conditioning operation switches provided on the operation panel 68 are input to the input side of the controller 60. Various types of air-conditioning operation switches provided on the operation panel 68 include an air conditioner switch, an automatic switch, an air volume setting switch for an interior blower, a vehicle-interior temperature setting switch, and the like.

The air conditioner switch is a switch for switching between operating and stopping (in other words, turning on and off) of air-conditioning (i.e., air-cooling or air-heating). The automatic switch is a switch for setting or resetting automatic control of the air-conditioning. The vehicle-interior temperature setting switch is an example of a target temperature setting portion that sets a target vehicle-interior temperature by the occupant's operation.

Now, the operation of the above-mentioned structure will be described. The controller 60 calculates a target air outlet temperature TAO of the air to be blown into the vehicle interior and switches between the air-heating mode and the non-air-heating mode based on the target air outlet temperature TAO. The air-heating mode is an air conditioning mode of heating the vehicle interior. The non-air-heating mode is an air conditioning mode in which the interior of the vehicle is not heated. The non-air-heating mode is an air-cooling mode of performing air-cooling of the vehicle interior, a blowing mode for blowing air into the vehicle interior, or the like.

The target air outlet temperature TAO of the air to be blown into the vehicle interior is calculated using, for example, the following mathematical expression:

TAO=Kset×Tset−Kr×Tr−Kam×Tam−Ks×As+C

where Tset is a vehicle interior preset temperature set by a vehicle interior temperature setting switch, Tr is an inside air temperature detected by the inside air temperature sensor 63, Tam is an outside air temperature, detected by the outside air temperature sensor 64, As is an amount of solar radiation detected by the solar radiation amount sensor 65, and Kset, Kr, Kam, and Ks are control gains, and C is a correcting constant.

The target air outlet temperature TAO corresponds to the amount of heat required for the vehicle thermal management device 10 to generate in order to keep the vehicle interior at a desired temperature, and can be regarded as an air conditioning load required for the vehicle thermal management device 10. In the air-heating mode, the target air outlet temperature TAO can be regarded as an air heating load required for the vehicle thermal management device 10.

When the target air outlet temperature TAO is higher than the inside air temperature Tr, the controller 60 executes the air-heating mode. When the target air outlet temperature TAO is lower than the inside air temperature Tr, the controller 60 executes the air-cooling mode.

The controller 60 switches among the operating modes shown in FIGS. 2 to 4 by controlling the operation of the switching valve 40.

In the first operating mode shown in FIG. 2, the condenser circuit 12 serves a circulation circuit through which the coolant circulates between the electric device 32 and the condenser 31. The condenser circuit 12 also serves as a circulation circuit in which the coolant circulates independently with respect to the engine cooling circuit 11.

In the first operating mode, as the coolant in the engine cooling circuit 11 circulates through the heater core 22, waste heat from the engine 21 is utilized to perform air-heating.

In the first operating mode, the coolant temperature in the condenser circuit 12 is maintained with the waste heat from the electric device 32. When the waste heat from the electric device 32 is little, the coolant temperature in the condenser circuit 12 is maintained higher than a predetermined lower limit of temperature with the heat supplied from the condenser 31.

By retaining waste heat from the electric device 32 in the condenser circuit 12, the waste heat from the electric device 32 can be used for air-heating and the like even when the coolant temperature in the engine cooling circuit 11 decreases due to an insufficient amount of heat in the engine cooling circuit 11.

That is, when the coolant temperature in the engine cooling circuit 11 decreases due to the insufficient amount of heat in the engine cooling circuit 11, the vehicle thermal management device is switched to the third operating mode, causing the coolant in the condenser circuit 12 to circulate to the heater core 22.

Consequently, the waste heat from the electric device 32 is used to heat the air in the heater core 22. When the waste heat from the electric device 32 is not sufficient, compared to heat required for air-heating or the like, the heat supplied from the condenser 31 is also used for air-heating or the like.

The second operating mode shown in FIG. 3 is executed when the amount of waste heat from the electric device 32 is large. In the second operating mode, the coolant flows through the second radiator 33 to dissipate heat from the coolant to the outside air. In this case, the second radiator path 12b is throttled by the fifth port 40e of the switching valve 40 so as to decrease the flow rate of the coolant flowing through the second radiator 33. The third port 40c of the switching valve 40 is throttled by a predetermined amount to cause the coolant to flow to the side of the second radiator 33 as well, leading to an increase in the pressure loss through a flow passage bypassing the second radiator 33.

The third operating mode shown in FIG. 4 is executed when the coolant temperature in the engine cooling circuit 11 is low. In the third operating mode, heat supplied from the condenser 31, waste heat from the electric device 32, and the like are used as a heat source for air-heating and the like. That is, the air-heating or the like is performed without operating the engine 21 for the purpose of air-heating. The air-heating or the like is performed by using the waste heat from the electric device 32 stored in the condenser circuit 12. Consequently, the waste heat from the electric device 32, which cannot be used in the first operating mode or the second operating mode, can be used.

In the first operating mode and the second operating mode, the shut-off valve 25 and the switching valve 40 circulate the coolant between the heater core 22 and the engine path portion 11a. In the third operating mode, the shut-off valve 25 and the switching valve 40 circulate the coolant between the heater core 22 and the condenser path portion 12a.

When the coolant temperature in the engine path portion 11a is higher than a predetermined switching temperature, the controller 60 executes the first operating mode. The switching temperature is, for example, 60° C. Thus, the coolant circulates between the heater core 22 and the engine path portion 11a, so that air-heating or the like can be performed using the waste heat from the engine 21. Since the condenser circuit 12 is a coolant circuit disposed independently of the engine cooling circuit 11, the waste heat from the electric device 32 is stored in the coolant within the condenser circuit 12.

When the coolant temperature of the engine cooling circuit 11 falls below the predetermined switching temperature in the first operating mode or the second operating mode, the controller 60 executes the third operating mode. Thus, the coolant circulates between the heater core 22 and the condenser path portion 12a. Thus, the air-heating or the like can be performed by using the waste heat from the electric device 32 stored in the coolant of the condenser circuit 12.

That is, when the air is heated by the heater core 22 using the waste heat from the engine 21, the waste heat from the electric device 32 is stored. When the waste heat from the engine 21 becomes insufficient as a heat source for air-heating or the like, the stored waste heat from the electric device 32 is used to perform air-heating or the like. Consequently, the waste heat from the electric device 32 can be effectively used for air-heating or the like.

The condenser circuit 12 can communicate with the second radiator 33. When the coolant temperature in the condenser circuit 12 becomes equal to or higher than a predetermined allowable temperature due to the waste heat from the electric device 32, the controller 60 opens the fifth port 40e of the switching valve 40 at a predetermined intermediate opening degree (in other words, a throttled opening degree), and flows the coolant to the second radiator 33 at an intermediate flow rate (in other words, a throttled flow rate). The allowable temperature is set in consideration of the heat-resistant temperature of the electric device 32. The allowable temperature is a temperature higher than the switching temperature, for example, 70° C.

Thus, the heat of the coolant in the condenser circuit 12 is dissipated into the outside air, thereby maintaining the coolant in the condenser circuit 12 at an allowable temperature or lower to protect the electric device 32. At this time, if the coolant flows to the second radiator 33 at a large flow rate, the coolant temperature drops rapidly when the outside air temperature is low. For this reason, the flow rate of the coolant in the second radiator 33 is limited.

The heating capability of the condenser 31 is adjustable by controlling the rotational speed of the compressor 51. When the heater core 22 is connected to the engine path portion 11a, the controller 60 controls the operation of the compressor 51 such that the coolant in the condenser circuit 12 remains at a predetermined retention temperature. The retention temperature is a little lower than the switching temperature. The retention temperature is, for example, 40° C.

Thus, the coolant temperature of the condenser circuit 12 can be maintained at a temperature close to the switching temperature. Consequently, when a connection destination of the heater core 22 is switched from the engine path portion 11a to the condenser path portion 12a, variations in the temperature of the coolant flowing into the heater core 22 can be suppressed, and thereby variations in the temperature of the air to be blown into the vehicle interior can also be suppressed.

When the timing for switching the connection of the heater core 22 from the side of the engine path portion 11a to the side of the condenser path portion 12a approaches, the controller 60 raises the coolant temperature in the condenser circuit 12 to a higher level than the retention temperature by heating the coolant in the condenser circuit 12 using the condenser 31.

Specifically, when the coolant temperature in the engine cooling circuit 11 is lower than a switching preparation temperature, the coolant temperature in the condenser circuit 12 is raised to a higher level than the retention temperature. The switching preparation temperature is a temperature slightly higher than the switching temperature. The switching preparation temperature is, for example, 70° C.

When a difference between the coolant temperature in the condenser circuit 12 and the coolant temperature in the engine cooling circuit 11 falls within an allowable range, the heater core 22 has its connection switched from the side of the engine path portion 11a to the side of the condenser path portion 12a. The allowable range is a temperature range that sets variations in the temperature of the coolant flowing into the heater core 22 allowable, and includes, for example, 3° C. That is, if the coolant temperature in the condenser circuit 12 and the coolant temperature in the engine cooling circuit 11 become approximately the same, the connection of the heater core 22 is switched from the side of the engine path portion 11a to the side of the condenser path portion 12a.

In other words, when the timing for switching the connection of the heater core 22 from the side of the engine path portion 11a to the side of the condenser path portion 12a is not approaching, the controller 60 does not heat the coolant in the condenser circuit 12 with the condenser 31 as much as possible.

Thus, when the heater core 22 is connected to the engine path portion 11a, the coolant temperature in the condenser circuit 12 does not need to be raised more than necessary, thus making it possible to reduce the power consumed by the compressor 51 for maintaining the coolant temperature in the condenser circuit 12.

When the coolant temperature in the engine cooling circuit 11 is lower than a required coolant temperature, the controller 60 raises the coolant temperature in the condenser circuit 12 to a higher level than the retention temperature. The required coolant temperature is the lower limit value of the coolant temperature required to keep the operation (specifically, combustion or sliding) of the engine 21 normal. The required coolant temperature is, for example, 40° C.

Thus, when the coolant temperature in the engine cooling circuit 11 is lower than the required coolant temperature, the heat of the coolant in the condenser path portion 12a is supplied to the coolant in the engine cooling circuit 11, so that consequently the coolant temperature in the engine path portion 11a can be maintained at a level equal to or higher than the required coolant temperature.

The switching preparation temperature or the required coolant temperature is a temperature rise starting temperature. When the coolant temperature in the engine cooling circuit 11 is lower than the temperature rise starting temperature, the controller 60 starts heating the coolant by the condenser 31 so as to raise the coolant temperature in the condenser circuit 12 to a higher level than the retention temperature.

As mentioned above, before the connection of the heater core 22 is switched from the side of the engine path portion 11a to the side of the condenser path portion 12a, the coolant in the condenser circuit 12 is heated by the condenser 31 to raise the coolant temperature in the condenser circuit 12 to the higher level than the retention temperature.

At this time, the lower the outside air temperature, the lower the performance of the refrigeration cycle 50 becomes. Consequently, the time required for raising the coolant temperature in the condenser circuit 12 is extended, and thereby it takes more time to switch the connection of the heater core 22.

In view of this, the controller 60 sets the retention temperature of the coolant in the condenser circuit 12 higher as an air-heating load becomes higher. Consequently, when the outside air temperature is low, a required coolant temperature rise range is restrained to shorten a switching required time.

The controller 60 performs the following control to minimize the power consumed by the compressor 51 when the coolant temperature is raised to a higher level than the retention temperature before switching the connection of the heater core 22 (hereinafter referred to as a “coolant temperature rise time”).

First, the controller calculates a time required to lower the coolant temperature in the engine cooling circuit 11 by a blowing variation allowable amount (the time being hereinafter referred to as a lowering time) based on the lowering speed of the coolant temperature in the engine cooling circuit 11. The blowing variation allowable amount is, for example, approximately 3° C.

Then, based on a heat pump performance map of the refrigeration cycle 50 and the like, the rotational speed and the operating time of the compressor 51 are determined such that the coolant temperature in the condenser circuit 12 becomes equal to the coolant temperature in the engine cooling circuit 11 when the lowering time has elapsed. As a result, the power consumption of the compressor 51 is optimized to the minimum necessary level, thereby enabling power saving.

The controller 60 changes the rotational speed of the compressor 51 exerted when the coolant temperature is raised, depending on the coolant temperature in the engine cooling circuit 11 or the coolant temperature in the condenser circuit 12.

For example, the controller 60 increases the rotational speed of the compressor 51 exerted when the coolant temperature is raised, as the lowering speed of the coolant temperature in the engine cooling circuit 11 increases. For example, the controller 60 increases the rotational speed of the compressor 51 exerted when the coolant temperature is raised, as the coolant temperature in the condenser circuit 12 decreases. For example, the controller 60 shortens the time from the start-up of the compressor 51 to the switching of the connection destination for the heater core 22 as the rotational speed of the compressor 51 increases.

In the present embodiment, when the shut-off valve 25 and the switching valve 40 circulate the coolant between the heater core 22 and the engine path portion 11a, the controller 60 controls the operations of the condenser 31 and the second radiator 33 (for example, the temperature adjusting capacities of the condenser 31 and the second radiator 33) such that the coolant temperature in the condenser path portion 12a becomes equal to or higher than the retention temperature (in other words, a predetermined temperature).

Thus, variations in the temperature of the coolant flowing into the heater core 22 can be suppressed when a state in which the coolant circulates between the heater core 22 and the engine path portion 11a is switched to a state in which the coolant circulates between the heater core 22 and the condenser path portion 12a. Thus, variations in the temperature of the air blown into the vehicle interior can be suppressed, thereby avoiding an occupant from feeling uncomfortable.

When the air conditioning mode is the non-air-heating mode, the occupant is less likely to feel uncomfortable even if the temperature of the air blown into the vehicle interior varies. In other words, when the air conditioning mode is the air-heating mode, the occupant is more likely to feel uncomfortable if the temperature of the air blown into the vehicle interior varies. In consideration of this point, the controller 60 increases the retention temperature in the air-heating mode, compared to the non-air-heating mode.

Thus, in the air-heating mode, the coolant temperature in the condenser path portion 12a can be increased, so that the occupant can be further avoided from feeling uncomfortable due to variations in the temperature of the air blown into the vehicle interior. In addition, in the non-air-heating mode, the coolant temperature in the condenser path portion 12a can be lowered, thereby enhancing the cooling efficiency of the electric device 32.

The higher the air-heating load, the higher the temperature of the coolant flowing into the heater core 22 needs to be. In consideration of this point, the controller 60 increases the retention temperature as the air-heating load increases. Specifically, the controller 60 increases the retention temperature as the target air outlet TAO becomes higher. As a result, even when the air-heating load is high, variations in the temperature of the coolant flowing into the heater core 22 can be suppressed.

In the present embodiment, when the coolant circulates between the heater core 22 and the engine path portion 11a, the controller 60 controls the operations of the shut-off valve 25 and the switching valve 40 such that the coolant circulates between the heater core 22 and the condenser path portion 12a if the coolant temperature in the engine path portion 11a becomes equal to or lower than the switching temperature. Then, the controller 60 sets the retention temperature equal to or lower than the switching temperature.

Thus, the power consumed for heating the coolant in the condenser 31 can be suppressed, compared to the case where the retention temperature is set higher than the switching temperature.

In the present embodiment, in a case where the coolant circulates between the heater core 22 and the engine path portion 11a, the controller 60 controls the operations of the shut-off valve 25 and the switching valve 40 such that the coolant circulates between the heater core 22 and the condenser path portion 12a when the coolant temperature in the engine path portion 11a becomes equal to or lower than the switching temperature, and when a temperature difference between the coolant in the engine path portion 11a and the coolant in the condenser path portion 12a is within the allowable range.

Thus, variations in the temperature of the coolant flowing into the heater core 22 can be suppressed when a state in which the coolant circulates between the heater core 22 and the engine path portion 11a is switched to a state in which the coolant circulates between the heater core 22 and the condenser path portion 12a.

In the present embodiment, when the coolant circulates between the heater core 22 and the engine path portion 11a, the controller 60 controls the operation of the condenser 31 to make the temperature of the coolant in the condenser path portion 12a higher than the retention temperature if the coolant temperature in the engine path portion 11a is lower than the temperature rise starting temperature. The temperature rise starting temperature is the switching preparation temperature or the required coolant temperature.

With this configuration, when the temperature rise starting temperature is the switching preparation temperature, if the timing for switching from the state in which the coolant circulates between the heater core 22 and the engine path portion 11a to the state in which the coolant circulates between the heater core 22 and the condenser path portion 12a approaches, the coolant temperature in the condenser path portion 12a is raised to a higher level than the retention temperature to be closer to the coolant temperature in the engine path portion 11a. Because of this, the retention temperature can be set lower. Thus, the power consumed by the compressor 51 can be reduced because the coolant temperature is adjusted in the condenser 31.

When the temperature rise starting temperature is the required coolant temperature, the heat of the coolant in the condenser path portion 12a is supplied to the coolant in the engine path portion 11a, so that the coolant temperature in the engine path portion 11a can be maintained at the required coolant temperature.

The power consumed by the compressor 51 can be reduced as the retention temperature is set lower. However, in a case where the retention temperature is set low, a coolant temperature rise range for bringing the coolant temperature in the condenser path portion 12a close to the coolant temperature in the engine path portion 11a becomes larger when the timing for switching the connection destination of the heater core 22 approaches. As a result, the coolant temperature in the condenser path portion 12a needs to be quickly raised.

When the rotational speed of the compressor 51 is increased, the coolant temperature in the condenser path portion 12a can be quickly raised. However, when the rotational speed of the compressor 51 is increased, the occupant is more likely to feel operating noise caused by the compressor 51 as abnormal noise. As the traveling speed of the vehicle is increased, wind noise becomes large. For this reason, when the rotational speed of the compressor 51 is increased, the operating noise of the compressor 51 is cancelled by the wind noise, and thereby an occupant is less likely to feel the operating noise of the compressor 51.

In view of this point, the controller 60 sets the retention temperature lower as the traveling speed of the vehicle becomes higher. Thus, the power consumed for maintaining the coolant temperature in the condenser path portion 12a at the retention temperature can be reduced. The traveling speed of the vehicle can be detected by a vehicle speed sensor (not shown).

In the present embodiment, the controller 60 determines the rotational speed of the compressor 51 based on the lowering speed of the coolant temperature in the engine path portion 11a, the switching temperature, and the coolant temperature in the condenser path portion 12a when the coolant circulates between the heater core 22 and the engine path portion 11a.

Thus, when the timing for switching the connection destination of the heater core 22 approaches, the coolant temperature in the condenser path portion 12a is raised to a higher level than the retention temperature to be closer to the coolant temperature in the engine path portion 11a, thereby making it possible to suppress the power consumed by the compressor 51.

The second radiator 33 dissipates heat of the coolant in the condenser path portion 12a into the outside air by exchanging heat between the coolant in the condenser path portion 12a and the outside air. Thus, the coolant temperature in the condenser path portion 12a can be suppressed from exceeding the allowable temperature due to waste heat from the electric device 32.

The refrigeration cycle 50 may be capable of reversing the refrigerant flow. When the refrigerant flow in the refrigeration cycle 50 is reversed, the low-pressure refrigerant decompressed and expanded by the expansion valve 52 flows to the condenser 31. Thus, the condenser 31 functions as a heat absorber for absorbing the heat of the coolant into the refrigerant.

That is, when the refrigerant flow in the refrigeration cycle 50 is reversed, the condenser 31 exchanges heat between the low-pressure side refrigerant in the refrigeration cycle 50 and the coolant in the condenser path portion 12a, thereby dissipating heat of the coolant in the condenser path portion 12a into the low-pressure side refrigerant in the refrigeration cycle 50.

Thus, the coolant temperature in the condenser path portion 12a can be suppressed from exceeding the allowable temperature due to waste heat from the electric device 32.

In the present embodiment, when the coolant circulates between the heater core 22 and the engine path portion 11a, the controller 60 controls the operation of the switching valve 40 so as to block the flow of the coolant in the condenser path portion 12a to the second radiator 33.

Thus, when the air-heating is performed using the waste heat from the engine 21, the waste heat from the electric device 32 can be suppressed from being dissipated into the outside air in the second radiator 33, so that the waste heat from the electric device 32 can be stored in the coolant in the condenser circuit 12.

Consequently, in a state where the coolant circulates between the heater core 22 and the condenser path portion 12a, the air-heating can be performed using the waste heat from the electric device 32, stored in the coolant within the condenser path portion 12a. In this way, the waste heat can be effectively used.

For example, the controller 60 controls the operations of the shut-off valve 25 and the switching valve 40 such that the coolant circulates between the heater core 22 and the condenser path portion 12a when the coolant temperature in the condenser path portion 12a exceeds the switching temperature.

In this way, the waste heat from the electric device 32, stored in the coolant in the condenser path portion 12a, can be effectively used for air-heating.

In the present embodiment, in a case where the coolant circulates between the heater core 22 and the engine path portion 11a, the controller 60 controls the operation of the switching valve 40 such that the coolant can flows to the second radiator 33 at a throttled rate when the coolant temperature in the condenser path portion 12a exceeds the allowable temperature.

Thus, the coolant temperature in the condenser path portion 12a can be suppressed from exceeding the heat-resistant temperature of the electric device 32.

In the present embodiment, when the coolant circulates between the heater core 22 and the engine path portion 11a, the controller 60 controls the operation of the condenser pump 30 so that the discharge flow rate of the coolant is reduced, compared to a case where the coolant circulates between the heater core 22 and the condenser path portion 12a.

Thus, the power consumption in the condenser pump 30 can be reduced when the waste heat from the electric device 32 is stored in the coolant within the condenser path portion 12a.

For example, in a case where the coolant circulates between the heater core 22 and the engine path portion 11a, the controller 60 controls the operation of the condenser pump 30 such that the discharge flow rate of the coolant is increased when the coolant temperature in the condenser path portion 12a exceeds the allowable temperature, compared to when the coolant temperature in the condenser path portion 12a is equal to or lower than the allowable temperature. As a result, the cooling of the electric device 32 can be suppressed from becoming insufficient.

For example, the controller 60 controls the operation of the condenser pump 30 such that the discharge flow rate of the coolant is increased when the coolant in the condenser path portion 12a flows to the second radiator 33, compared to when the flow of the coolant of the condenser path portion 12a to the second radiator 33 is blocked. As a result, the cooling of the electric device 32 can be suppressed from becoming insufficient.

### Other Embodiments

Various modifications and changes can be made to the above-mentioned embodiments, for example, in the following way.
(1) Although in the above-mentioned embodiment, the coolant temperature in the condenser circuit 12 is adjusted by the condenser 31 and the second radiator 33, the coolant temperature in the condenser circuit 12 may be adjusted by an electric heater or a combustion type heater.

The coolant temperature in the condenser circuit 12 may be adjusted by a heat exchanger that can adjust a heat receiving capability of waste heat from other heat sources. The heat exchanger that can adjust a heat receiving capability of waste heat from other heat sources is, for example, a heat exchanger that exchanges heat between the coolant in the condenser circuit 12 and the coolant in the other coolant circuit.
(2) Although in the above-mentioned embodiment, the switching valve 40 is the five-way valve, a plurality of two-way valves and/or three-way valves may be used instead of the five-way valve.
(3) Although in the above-mentioned embodiments, the coolant is used as the heat medium that flows through the engine cooling circuit 11 and the condenser circuit 12, various kinds of media, such as oil, may be used as the heat medium.

Alternatively, nanofluid may be used as the heat medium. The nanofluid is a fluid containing nanoparticles having a particle diameter of the order of nanometer. By mixing the nanoparticles into the heat medium, the following functions and effects can be obtained, in addition to the function and effect of decreasing a freezing point, like a coolant (so-called antifreeze) using ethylene glycol.

That is, the use of the nanoparticles can exhibit the functions and effects of improving the thermal conductivity in a specific temperature range, increasing the thermal capacity of the heat medium, preventing the corrosion of a metal pipe and the degradation of a rubber pipe, and enhancing the fluidity of the heat medium at an ultralow temperature.

These functions and effects are varied depending on the configuration, shape, and blending ratio of the nanoparticles, and additive material.

Thus, the mixture of nanoparticles in the heat medium can improve its thermal conductivity, and even in a small amount, can exhibit substantially the same cooling efficiency as the coolant using ethylene glycol.

Further, such a heat medium can also increase its thermal capacity and thereby can increase a cold storage amount of the heat medium itself. The cold storage amount of the heat medium itself is the amount of cold heat stored by sensible heat.

By increasing the cold storage amount, the temperature adjustment, including cooling and heating, of any device can be performed using the cold storage heat for some period of time even though the compressor 51 is not operated, thus enabling power saving of the vehicle thermal management system 10.

An aspect ratio of the nanoparticle is preferably 50 or more. This is because such an aspect ratio can provide the adequate thermal conductivity. Note that the aspect ratio of the nanoparticle is a shape index indicating the ratio of the width to the height of the nanoparticle.

Nanoparticles suitable for use can include any one of Au, Ag, Cu, and C. Specifically, examples of constituent atoms of the nanoparticles can include an Au nanoparticle, an Ag nanowire, a CNT, a graphene, a graphite core-shell nanoparticle, an Au nanoparticle-containing CNT, and the like. CNT is a carbon nanotube. The graphite core-shell nanoparticle is a particle body with the above-mentioned atom surrounded by a structure, such as a carbon nanotube.
(4) In the refrigeration cycle 50 of the above-mentioned embodiments, a fluorocarbon refrigerant is used as the refrigerant. However, the kind of refrigerant is not limited thereto, and natural refrigerant, such as carbon dioxide, a hydrocarbon refrigerant, and the like may be used.
(5) The refrigeration cycle 50 in the above-mentioned embodiments constitutes a subcritical refrigeration cycle in which its high-pressure side refrigerant pressure does not exceed the critical pressure of the refrigerant, but may constitute a super-critical refrigeration cycle in which its high-pressure side refrigerant pressure exceeds the critical pressure of the refrigerant.

1. A thermal management device for a vehicle, comprising:
a first heat medium path portion and a second heat medium path portion, through which a heat medium flows;
a waste-heat supply device configured to supply waste heat to the heat medium flowing through the second heat medium path portion;
a heating heat exchanger that exchanges heat between air to be blown into a vehicle interior and the heat medium to heat the air;
a switching portion that switches between a state in which the heat medium circulates between the heating heat exchanger and the first heat medium path portion, and a state in which the heat medium circulates between the heating heat exchanger and the second heat medium path portion;
an adjustment portion configured to adjust a temperature of the heat medium in the first heat medium path portion; and
a controller configured to control an operation of the adjustment portion such that the temperature of the heat medium in the first heat medium path portion is equal to or higher than a predetermined temperature when the switching portion is set to circulate the heat medium between the heating heat exchanger and the second heat medium path portion.

2. The thermal management device for a vehicle according to claim 1, wherein
the controller increases the predetermined temperature in an air-heating mode in which air-heating of the vehicle interior is performed, compared to a non-air-heating mode in which air-heating of the vehicle interior is not performed.

3. The thermal management device for a vehicle according to claim 1, wherein
the controller increases the predetermined temperature as an air-heating load becomes higher.

4. The thermal management device for a vehicle according to claim 1, wherein
in a case where the heat medium circulates between the heating heat exchanger and the second heat medium path portion, the controller controls an operation of the switching portion to circulate the heat medium between the heating heat exchanger and the first heat medium path portion when a temperature of the heat medium in the second heat medium path portion is equal to or lower than a switching temperature, and
the predetermined temperature is set at a temperature equal to or lower than the switching temperature.

5. The thermal management device for a vehicle according to claim 1, wherein
in a case where the heat medium circulates between the heating heat exchanger and the second heat medium path portion, the controller controls an operation of the switching portion to circulate the heat medium between the heating heat exchanger and the first heat medium path portion, (i) when a temperature of the heat medium in the second heat medium path portion is equal to or lower than a switching temperature, and (ii) when a temperature difference between the heat medium in the second heat medium path portion and the heat medium in the first heat medium path portion is within an allowable range.

6. The thermal management device for a vehicle according to claim 5, wherein
when the heat medium circulates between the heating heat exchanger and the second heat medium path portion, the controller controls an operation of the adjustment portion to make the temperature of the heat medium in the first heat medium path portion higher than the predetermined temperature if the temperature of the heat medium in the second heat medium path portion is lower than a temperature rise starting temperature.

7. The thermal management device for a vehicle according to claim 6, further comprising:
a compressor that draws a low-pressure refrigerant in a refrigeration cycle, and discharges a high-pressure refrigerant, wherein
the adjustment portion includes a heat exchanger that exchanges heat between the high-pressure refrigerant and the heat medium to heat the heat medium, and
the controller sets the predetermined temperature to be lower as a traveling speed of the vehicle becomes higher.

8. The thermal management device for a vehicle according to claim 6, further comprising:
a compressor that draws a low-pressure refrigerant in a refrigeration cycle, and discharges a high-pressure refrigerant, wherein
the adjustment portion includes a heat exchanger that exchanges heat between the high-pressure refrigerant and the heat medium to heat the heat medium, and
the controller determines a rotational speed of the compressor based on a lowering speed of the temperature of the heat medium in the second heat medium path portion, the switching temperature, and the temperature of the heat medium in the first heat medium path portion, when the heat medium circulates between the heating heat exchanger and the second heat medium path portion.

9. The thermal management device for a vehicle according to claim 1, wherein
the waste-heat supply device is a second waste-heat supply device, the thermal management device further comprising:
a first waste-heat supply device configured to supply waste heat to the heat medium flowing through the first heat medium path portion, wherein
the adjustment portion includes an outside-air heat radiator that dissipates heat of the heat medium in the first heat medium path portion into outside air by exchanging heat between the heat medium in the first heat medium path portion and the outside air.

10. The thermal management device for a vehicle according to claim 1, wherein
the waste-heat supply device is a second waste-heat supply device, the thermal management device further comprising:
a first waste-heat supply device configured to supply waste heat to the heat medium flowing through the first heat medium path portion, wherein
the adjustment portion includes a heat exchanger that exchanges heat between a low-pressure refrigerant in a refrigeration cycle and the heat medium to dissipate heat of the heat medium into the low-pressure refrigerant.

11. A thermal management device for a vehicle comprising:
a first waste-heat supply device configured to supply waste heat to a heat medium;
a second waste-heat supply device configured to supply waste heat to the heat medium, the second waste-heat supply device having a high allowable temperature, compared to the first waste-heat supply device;
a heating heat exchanger that exchanges heat between air to be blown into a vehicle interior and the heat medium to heat the air;
a first heat medium path portion through which the heat medium flows, and in which the first waste-heat supply device is disposed;
a second heat medium path portion through which the heat medium flows, and in which the second waste-heat supply device is disposed;
an outside-air heat radiator that dissipates heat of the heat medium in the first heat medium path portion into outside air by exchanging heat between the heat medium in the first heat medium path portion and the outside air;
a switching portion configured to switch between a state in which the heat medium in the first heat medium path portion flows to the outside-air heat radiator and a state in which a flow of the heat medium in the first heat medium path portion to the outside-air heat radiator is blocked, while switching between a state in which the heat medium circulates between the heating heat exchanger and the first heat medium path portion and a state in which the heat medium circulates between the heating heat exchanger and the second heat medium path portion; and
a controller configured to control an operation of the switching portion such that the flow of the heat medium in the first heat medium path portion to the outside-air heat radiator is blocked when the heat medium circulates between the heating heat exchanger and the second heat medium path portion.

12. The thermal management device for a vehicle according to claim 11, wherein
the controller controls an operation of the switching portion such that the heat medium circulates between the heating heat exchanger and the first heat medium path portion when a temperature of the heat medium in the first heat medium path portion exceeds a switching temperature.

13. The thermal management device for a vehicle according to claim 11, wherein
in a case where the heat medium circulates between the heating heat Exchanger and the second heat medium path portion, the controller controls an operation of the switching portion such that the heat medium flows through the outside-air heat radiator at a throttled flow rate when a temperature of the heat medium in the first heat medium path portion exceeds an allowable temperature.

14. The thermal management device for a vehicle according to claim 11, further comprising:
a pump that draws and discharges the heat medium in the first heat medium path portion, wherein
the controller controls an operation of the pump such that a discharge flow rate of the heat medium is reduced when the heat medium circulates between the heating heat exchanger and the second heat medium path portion, compared to that when the heat medium circulates between the heating heat exchanger and the first heat medium path portion.

15. The thermal management device for a vehicle according to claim 14, further comprising:
a pump that draws and discharges the heat medium in the first heat medium path portion, wherein
in a case where the heat medium circulates between the heating heat exchanger and the second heat medium path portion, the controller controls an operation of the pump such that a discharge flow rate of the heat medium is increased when a temperature of the heat medium in the first heat medium path portion exceeds an allowable temperature, compared to when a temperature of the heat medium in the first heat medium path portion is equal to or lower than the allowable temperature.

16. The thermal management device for a vehicle according to claim 14, further comprising:
a pump that draws and discharges the heat medium in the first heat medium path portion, wherein
the controller controls an operation of the pump such that a discharge flow rate of the heat medium is increased when the heat medium in the first heat medium path portion flows to the outside-air heat radiator, compared to that when a flow of the heat medium in the first heat medium path portion to the outside-air heat radiator is blocked.

17. A thermal management device for a vehicle, comprising:
a first heat medium path portion and a second heat medium path portion, through which a heat medium flows;
a waste-heat supply device configured to supply waste heat to the heat medium flowing through the second heat medium path portion;
a heating heat exchanger that exchanges heat between air to be blown into a vehicle interior and the heat medium to heat the air;
a switching valve that switches between a first state in which the heat medium circulates between the heating heat exchanger and the first heat medium path portion, and a second state in which the heat medium circulates between the heating heat exchanger and the second heat medium path portion; and
a controller configured
to control a temperature of the heat medium in the first heat medium path portion equal to or higher than a predetermined temperature in the second state, and
to control the switching valve to be switched to the first state, when a temperature of the heat medium in the second heat medium path portion is equal to or lower than a switching temperature in the second state,
wherein the predetermined temperature is a temperature equal to or lower than the switching temperature.
